(19) United States
(12) Patent Application Publication
(10) Pub. No.: US 2011/0062152 A1
(43) Pub. Date: Mar. 17, 2011

(54) HIGH-FREQUENCY HEATING APPARATUS WITH ELECTROTHERMIC HEATING DEVICE

(75) Inventors: Mikio Fukui, Osaka (JP); Hisahiro Nishitani, Osaka (JP); Yoshio Semori, Osaka (JP)

(73) Assignee: PANASONIC CORPORATION, OSAKA (JP)

(21) Appl. No.: 12/992,734

(22) PCT Filed: May 13, 2009
(86) PCT No.: PCT/JP2009/002070

§ 371 Date: Nov. 15, 2010

(30) Foreign Application Priority Data
May 16, 2008 (JP) 2008-129393

(51) Int. Cl. H05B 6/68

(52) U.S. Cl. 219/702

(57) ABSTRACT

There is provided a high-frequency heating apparatus with an electrothermic heating device, including a heating chamber that houses an object to be heated, a high-frequency generating device and an electrothermic heating device for heating the object to be heated, and two overheat prevention devices provided in the electrothermic heating device, wherein the two overheat prevention devices are a first stage overheat prevention device of a resettable type and a second stage overheat prevention device of a non-resettable type, and an operating temperature of the second stage overheat prevention device is set higher than an operating temperature of the first stage temperature overheat prevention device.

### TECHNICAL FIELD

The present invention relates to ensuring of safety at a time of electrothermic heating in a high-frequency heating apparatus with an electrothermic heating device for heating food.

### BACKGROUND ART

Conventionally, this kind of high-frequency heating apparatus with an electrothermic heating device includes one non-resettable type overheat prevention device in an electrothermic heating device. When a heater comes into a continuously conducting state due to some failure such as a heater relay short circuit, an overheat prevention device therefor operates to prevent occurrence of fire, electric shock, and the like.

FIG. 4 is a top view of an electrothermic heating device of a conventional high-frequency heating apparatus with an electrothermic heating device. Electrothermic heating device 53 is mounted on heating chamber 51. Further, electrothermic heating device 53 supplies hot air to heating chamber 51. Electrothermic heating device 53 is mounted with thermistor 62 and overheat prevention device 59. Thermistor 62 controls a temperature of heating chamber 51. Overheat prevention device 59 operates at a time of an abnormal temperature increase to prevent occurrence of ignition, electric shock, and the like.

For example, Patent Literature 1 describes a technique as above in which thermistor 62 and overheat prevention device 59 are provided and a stop signal is transmitted to the heating device at a time of temperature information from thermistor 62 becoming higher than a predetermined temperature, to make the heating device stop its operation.

In the conventional high-frequency heating apparatus with an electrothermic heating device, an operating temperature of overheat prevention device 59 is set higher by a margin than a temperature at a normal time in order to prevent overheat prevention device 59 from operating at the normal time. There has thus been a problem in that the heating apparatus cannot be prevented from coming into a “minor abnormal temperature state”, such as a state where a temperature of a shell of a commodity product becomes high, which is caused by failure of temperature control device 59 or the like, and reduces life time of parts.

### PATENT LITERATURE

PTL 1: Unexamined Japanese Patent Publication No. 2005-63884

### DISCLOSURE OF THE INVENTION

A high-frequency heating apparatus with an electrothermic heating device according to the present invention includes: a heating chamber that houses an object to be heated; a high-frequency generating device and an electrothermic heating device for heating the object to be heated; and two overheat prevention devices provided in the electrothermic heating device, wherein the two overheat prevention devices are a first stage overheat prevention device of a resettable type and a second stage overheat prevention device of a non-resettable type, and an operating temperature of the second stage overheat prevention device is set higher than an operating temperature of the first stage temperature overheat prevention device.

In such a high-frequency heating apparatus with an electrothermic heating device, the first stage overheat prevention device is a resettable type, and the operating temperature of the second stage overheat prevention device is set higher than the operating temperature of the first stage temperature overheat prevention device. Therefore, even when the high-frequency heating apparatus with an electrothermic heating device comes into a very minor abnormal temperature state, the apparatus can be prevented from coming into the minor abnormal temperature state, so as to be continuously used.

Further, with the second stage overheat prevention device being the non-resettable type, when the first stage overheat prevention device gets out of order due to aged deterioration or the like, the second stage overheat prevention device operates. This disables the high-frequency heating apparatus with an electrothermic heating device to be continuously used, so that safety can be ensured.

### BRIEF DESCRIPTION OF THE DRAWINGS

FIG. 1 is a top view of a high-frequency heating apparatus with an electrothermic heating device in an embodiment of the present invention.

FIG. 2 is a block diagram of the high-frequency heating apparatus with the electrothermic heating device in the embodiment.

FIG. 3 is a graph showing increases in temperature of overheat prevention device sensing sections (thermoswitches) of the high-frequency heating apparatus with the electrothermic heating device in the embodiment.

FIG. 4 is a top view of an electrothermic heating device of a conventional high-frequency heating apparatus with the electrothermic heating device in the embodiment.

### DETAILED DESCRIPTION OF THE PREFERRED EMBODIMENTS

Hereinafter, an embodiment of the present invention is described with reference to the drawings. It is to be noted that the present invention is not limited by this embodiment.

### Embodiment

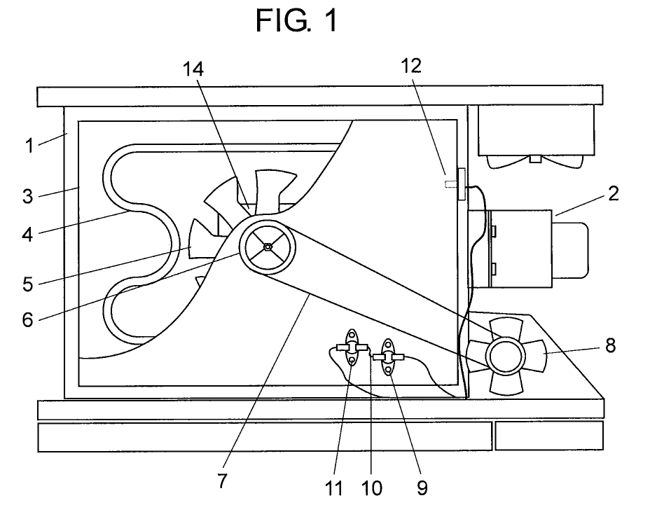

FIG. 1 is a top view of a high-frequency heating apparatus with an electrothermic heating device in an embodiment of the present invention. Object 14 to be heated which is housed in heating chamber 1 is heated by high-frequency heating unit 2 and electrothermic heating device 3. Heat generated by heater 4 is turned by circulating fan 5 into hot air, which circulates between electrothermic heating device 3 and heating chamber 1. Circulating fan 5 is coupled with circulating fan pulley 6, and rotated by belt 7 and circulating fan motor 8.

A temperature of heating chamber 1 is measured by thermistor 12. Data on the temperature of heating chamber 1 is then transmitted to a first stage thermoswitch (overheat prevention device) 9 and second stage thermoswitch (overheat prevention device) 11. First stage thermoswitch 9 and second stage thermoswitch 11 are fixed with screws at a top of electrothermic heating device 3, and serially connected to each other with lead wire 10.

Specifically, the high-frequency heating apparatus with an electrothermic heating device according to the present invention is provided with first stage thermoswitch 9 and second stage thermoswitch 11. Herein, first stage thermoswitch 9 is a resettable type thermoswitch and second stage thermoswitch 11 is a non-resettable type thermoswitch. An operating temperature of second stage thermoswitch 11 is set higher than an operating temperature of first stage thermoswitch 9.

FIG. 2 is a block diagram of the high-frequency heating apparatus with an electrothermic heating device in the embodiment of the present invention. First stage thermoswitch 9 is serially connected with heater 4, and second stage thermoswitch 11 is located between a power source and other loads. Control section 13 controls a circuit such as a relay.

Hereinafter described are operations and functions of the high-frequency heating apparatus with an electrothermic heating device, which is configured as thus described.

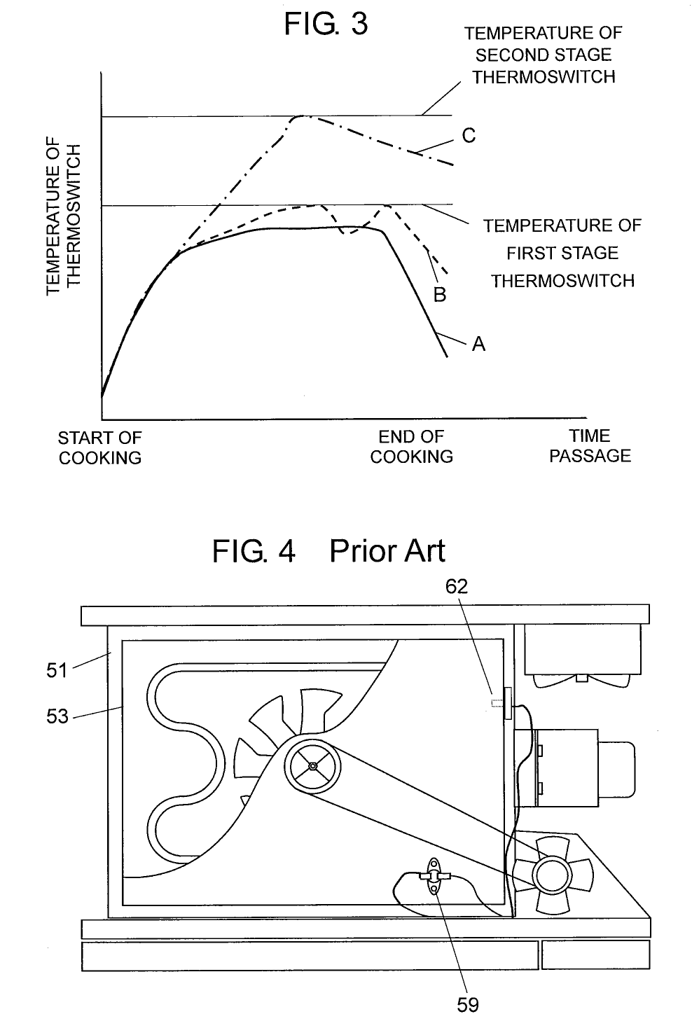

FIG. 3 is a graph showing increases in temperature of the overheat prevention device sensing sections (thermoswitches) of the high-frequency heating apparatus with an electrothermic heating device in the embodiment of the present invention. Curves A, B and C respectively indicate increases in temperature of thermoswitches at the normal time, at the time of a very minor abnormal temperature increase, and at the time of a seriously abnormal temperature increase when first stage thermoswitch 9 gets out of order.

In the embodiment of the present invention, an operating temperature of resettable-type first stage thermoswitch 9 is set with a small margin from a temperature at the normal time. Hence as shown with curve B of FIG. 3, even when first stage thermoswitch 9 detects a very minor abnormal temperature increase of the high-frequency heating apparatus with an electrothermic heating device, the high-frequency heating apparatus with an electrothermic heating device repeatedly stops and operates, so as to prevent occurrence of a minor abnormal temperature increase.

Further, the first stage thermoswitch 9 is a resettable type, and the operating temperature of second stage thermoswitch 11 is set higher than the operating temperature of first stage thermoswitch 9. It is thereby possible to continuously use the high-frequency heating apparatus with an electrothermic heating device in a range of the very minor abnormal temperature increase.

Moreover, as shown in curve C of FIG. 3, when first stage thermoswitch 9 gets out of order due to aged deterioration or the like, non-resettable-type second stage thermoswitch 11 operates. This results in making the high-frequency heating apparatus with an electrothermic heating device non-reusable.

As described above, according to the embodiment of the present invention, it is possible to prevent the high-frequency heating apparatus with an electrothermic heating device from coming into a state of a minor abnormal temperature increase, and also to continuously use the high-frequency heating apparatus with an electrothermic heating device.

### INDUSTRIAL APPLICABILITY

The present invention is applied to a high-frequency heating apparatus with an electrothermic heating device for heating of food.

### REFERENCE MARKS IN THE DRAWINGS

1 heating chamber

2 high-frequency heating unit

3 electrothermic heating device

4 heater

5 circulating fan

6 circulating fan pulley

7 belt

8 circulating fan motor

9 first stage thermoswitch

10 lead wire

11 second stage thermoswitch

12 thermistor

13 control section

14 object to be heated

What is claimed is:

1. A high-frequency heating apparatus with an electrothermic heating device, comprising:
a heating chamber that houses an object to be heated;
a high-frequency generating device and an electrothermic heating device for heating the object to be heated; and
two overheat prevention devices provided in the electrothermic heating device, wherein
the two overheat prevention devices are a first stage overheat prevention device of a resettable type and a second stage overheat prevention device of a non-resettable type, and
an operating temperature of the second stage overheat prevention device is set higher than an operating temperature of the first stage temperature overheat prevention device.
